(19) United States
(12) Patent Application Publication
(10) Pub. No.: US 2020/0070237 A1
(43) Pub. Date: Mar. 5, 2020

(54) JOINT STRUCTURE

(71) Applicant: OLYMPUS CORPORATION, Tokyo (JP)

(72) Inventor: Kazuhiro YAMAGATA, Tokyo (JP)

(73) Assignee: OLYMPUS CORPORATION, Tokyo (JP)

(21) Appl. No.: 16/676,662

(22) Filed: Nov. 7, 2019

Related U.S. Application Data
(63) Continuation of application No. PCT/JP2018/017582, filed on May 7, 2018.

(30) Foreign Application Priority Data
May 8, 2017 (JP) 2017-092185

(51) Int. Cl. B21J 15/04; F16C 11/04

(52) U.S. Cl. CPC B21J 15/04; F16C 11/04

(57) ABSTRACT

A method of manufacturing a joint structure, includes: setting a shaft in a pre-fixed state in which the shaft is not fixed to a fixed part while the shaft is inserted into a through hole formed through a movable part, and a distal end of the shaft is inserted into a through hole formed through the fixed part; inserting a punch into an opening of a counterbore while swinging the punch; pressing, by lowering the punch while swinging the punch in the counterbore, sides of the punch alternately against sides of an inner curved surface of the counterbore according to the swinging of the punch; and fixing the shaft to the fixed part by enlarging an inner diameter of the counterbore to make the distal end of the shaft be closely in contact with the inner curved surface of the through hole of the fixed part.

This application is a continuation of PCT International Application No. PCT/JP2018/017582 filed on May 7, 2018, which designates the United States, incorporated herein by reference, and which claims the benefit of priority from Japanese Patent Application No. 2017-092185, filed on May 8, 2017, incorporated herein by reference.

### BACKGROUND

The present disclosure relates to a joint structure.

For example, JP 3238638 B2 discloses a known joint structure. In the known joint structure, a connection pin is inserted in ends of a plurality of linkage parts. A distal end of the connection pin protrudes from a side of the linkage parts. A diameter of the distal end is enlarged by hitting the distal end with a hammer or the like. Consequently, the connection pin supports the linkage parts that are rotatable.

### SUMMARY

According to one aspect of the present disclosure, there is provided a method of manufacturing a joint structure including a movable part, a fixed part that is close to the movable part, and a shaft configured to connect the movable part with the fixed part, the method including: setting the shaft in a pre-fixed state in which the shaft is not fixed to the fixed part while the shaft is inserted into a through hole formed through the movable part, and a distal end of the shaft protruding from the through hole of the movable part is inserted into a through hole formed through the fixed part; inserting a punch for riveting into an opening of a counterbore while swinging the punch, the punch including a distal end having a width narrower than a width of the counterbore formed at the distal end of the shaft, and the punch having a width gradually increasing from the distal end of the punch toward a proximal end of the punch; pressing, by lowering the punch while swinging the punch in the counterbore, sides of the punch alternately against sides of an inner curved surface of the counterbore according to the swinging of the punch; and fixing the shaft to the fixed part by enlarging an inner diameter of the counterbore to make the distal end of the shaft be closely in contact with the inner curved surface of the through hole of the fixed part.

The above and other features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a cross-sectional view that illustrates a configuration of a joint structure according to an embodiment;

FIG. 2 is an enlarged cross-sectional view that illustrates a shaft and a rivet plate that have not been riveted in the joint structure according to the embodiment;

FIG. 3 is an enlarged cross-sectional view that illustrates the shaft and the rivet plate that have been riveted in the joint structure according to the embodiment;

FIG. 4 is an enlarged cross-sectional view that illustrates a shaft and a rivet plate that have not been riveted in a joint structure according to a variation of the embodiment; and

FIG. 5 is an enlarged cross-sectional view that illustrates the shaft and the rivet plate that have been riveted in the joint structure according to the variation of the embodiment.

### DETAILED DESCRIPTION

Hereinafter, joint structures according to embodiments will be described with reference to the drawings. The present disclosure is not limited to embodiments described later. Components of the embodiments described later include things with which the components of the embodiments described later are easily replaced by a person skilled in the art. Alternatively, the components of the embodiments described later include things that are substantially same as the components of the embodiments described later.

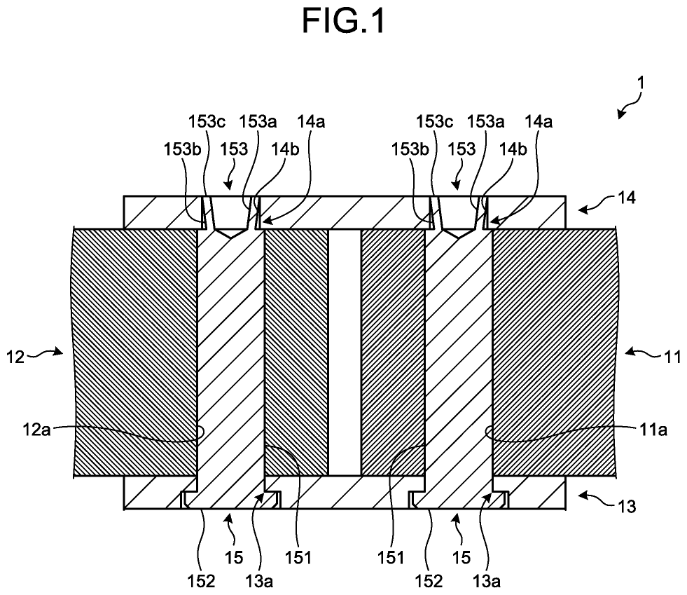

First, a configuration of a joint structure according to an embodiment will be described with reference to FIG. 1. A joint structure 1 is used as a joint of a plurality of linkage parts, for example. As illustrated in FIG. 1, the joint structure 1 includes a plurality of (two in the present embodiment) arms 11, 12, a fixing plate 13, a rivet plate 14, and a plurality of (two in the present embodiment) shafts 15.

The arms (movable parts) 11, 12 are rod-shaped, and are opposite each other. There is a predetermined space between the arms 11, 12. A through hole 11a is formed through an end of the arm 11. A main body 151 of one of the shafts 15 is inserted in the through hole 11a. A through hole 12a is formed through an end of the arm 12. A main body 151 of the other shaft 15 is inserted in the through hole 12a. Consequently, the arms 11, 12 pivot around the respective shafts 15 and relative to the fixing plate 13 and the rivet plate 14.

The fixing plate 13 is plate-shaped, and is close to a side, on one side, of the arm 11, and is close to a side, on one side, of the arm 12. A plurality of (two in the present embodiment) stepped holes 13a are formed through the fixing plate 13. Each of the stepped holes 13a is constituted by a through hole that has a diameter that is same as a diameter of the through hole 11a, 12a, and a through hole that has a diameter that is larger than the diameter of the through hole 11a, 12a. A head 152 of the shaft 15 is disposed in the stepped hole 13a.

The rivet plate (fixed part) 14 is plate-shaped, and is close to a side, on the other side, of the arm 11, and is close to a side, on the other side, of the arm 12. A plurality of (two in the present embodiment) through holes 14a are formed through the rivet plate 14. The through holes 14a have a diameter that is smaller than the diameter of the through hole 11a, 12a. Joining portions 153 of the shafts 15 are inserted in the respective through holes 14a. The through holes 14a are cylindrical and each have a uniform inner diameter.

The through holes 11a, 12a of the arms 11, 12, the stepped holes 13a of the fixing plate 13, and the through holes 14a of the rivet plate 14 are coaxial and concentric.

The shafts (connection pins) 15 connect the arms 11, 12 with the rivet plate 14. Each of the shafts 15 as a whole is rod-shaped. The shaft 15 includes the main body 151, the head 152, and the joining portion 153. The main body 151 is column-shaped. The main bodies 151 are inserted in the through holes 11a, 12a of the arms 11, 12. The main bodies 151 support the arms 11, 12 that are rotatable.

The head 152 is dish-shaped, and has an outer diameter that is larger than an outer diameter of the main body 151. The head 152 is disposed in the stepped hole 13a of the fixing plate 13. The head 152 engages with the stepped hole 13a.

The joining portion 153 is cylindrical, and has an outer diameter that is smaller than the outer diameter of the main body 151. The joining portion 153 is inserted in the through hole 14a of the rivet plate 14. The joining portion 153 supports the rivet plate 14 that is not rotatable.

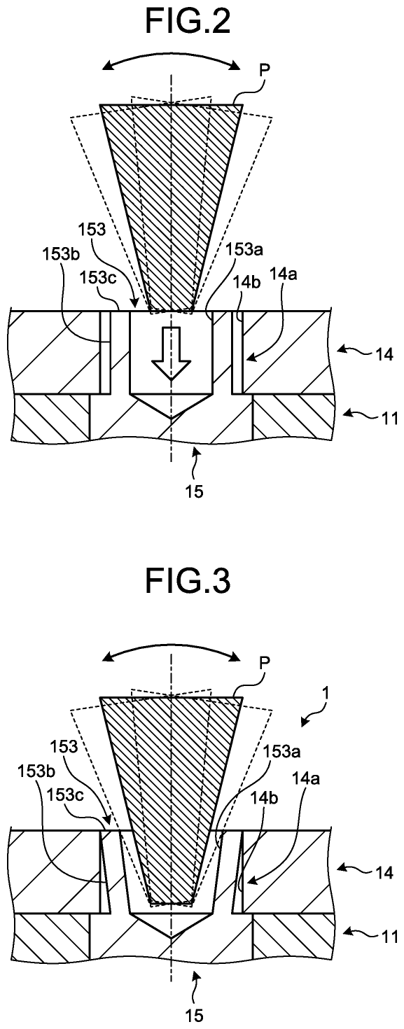

A counterbore 153a is formed at a distal end 153c of the joining portion 153 and has a predetermined depth. A cross-sectional shape of the counterbore 153a is cylindrical and has an inner diameter that is uniform before the joining portion 153 is fixed to the through hole 14a of the rivet plate 14 by riveting described later (see FIG. 2). The inner diameter of the counterbore 153a is enlarged by the riveting described later. Consequently, the cross-sectional shape of the counterbore 153a tapers as illustrated in FIG. 1.

At least part of an outer curved surface 153b of the joining portion 153 is closely in contact with an inner curved surface 14b of the through hole 14a of the rivet plate 14. The distal end 153c of the joining portion 153 is at a height that is same as a height of an end, on an opening side, of the through hole 14a of the rivet plate 14. Therefore, the distal end 153c of the joining portion 153 does not protrude from the end, on an opening side, of the through hole 14a. In other words, the distal end 153c of the joining portion 153 does not protrude from a side of the rivet plate 14.

Hereinafter, a method of fixing the shaft 15 of the joint structure 1 to the rivet plate 14 of the joint structure 1 (a method of manufacturing the joint structure 1) will be described with reference to FIGS. 2 and 3. In FIG. 2, the shaft 15 inserted in the arm 11 has not been fixed to the rivet plate 14. As illustrated in FIG. 2, the counterbore 153a of the joining portion 153 of the shaft 15 is cylindrical and has an inner diameter that is uniform before the shaft 15 is fixed to the rivet plate 14. Therefore, there is a predetermined clearance between the outer curved surface 153b of the joining portion 153 and the inner curved surface 14b of the through hole 14a.

In the present embodiment, a radial riveting machine (not illustrated) is used to rivet the joining portion 153 of the shaft 15, and thus enlarge the inner diameter of the counterbore 153a. The radial riveting machine presses a punch P illustrated in FIG. 2 against a part such as a shaft while the radial riveting machine makes the punch P move radially and axially. Consequently, the part plastically deforms. The punch P attached to the radial riveting machine (not illustrated) is configured to swing within a range defined by a broken line in FIG. 2 by moving radially and axially. An axial center of the radial riveting machine (a center of the radial and axial movement) is determined to correspond to a center of the counterbore 153a.

While the axial center of the radial riveting machine corresponds to a center of the counterbore 153a, the punch P is lowered in an axial direction of the shaft 15 while the punch P is swung. Consequently, a side of the punch P is pressed against an inner curved surface of the counterbore 153a, as illustrated in FIG. 3, and thus an inner diameter of the counterbore 153a is enlarged. Consequently, as illustrated in FIG. 3, part of the outer curved surface 153b of the joining portion 153 is closely in contact with the inner curved surface 14b of the through hole 14a of the rivet plate 14. Consequently, the shaft 15 is fixed to the rivet plate 14. In FIGS. 2 and 3, the shaft 15 inserted in the arm 11 is riveted, as an example. Further, the shaft 15 inserted in the arm 12 is similarly riveted. Consequently, the two shafts 15 are fixed to the rivet plate 14, and thus the two arms 11, 12 are connected.

In the joint structure 1 described above, the joining portions 153 are fixed to the through holes 14a of the rivet plate 14 by enlarging inner diameters of the counterbores 153a formed at the distal ends 153c of the joining portions 153. Therefore, since a force that is in an axial direction of the shaft 15 does not act at a time of riveting (or an axial force is slight), the shaft 15 does not deform. For example, the shaft 15 does not swell or buckling does not occur at the shaft 15. Therefore, good movement of the arms 11, 12 is secured.

The joining portions 153 are fixed to the through holes 14a of the rivet plate 14 by enlarging inner diameters of the counterbores 153a. Therefore, the distal ends 153c of the shafts 15 do not protrude from a side of the rivet plate 14. Therefore, a size of the joint structure 1 is reduced. For example, a connection pin that is long enough to protrude from a side of a linkage part is prepared for a joint structure disclosed in JP 3238638 B2. A diameter of a distal end of the connection pin is enlarged by hitting and deforming the distal end of the connection pin. Therefore, it is difficult not to allow the connection pin to protrude from a side of the linkage part. On the other hand, the shafts 15 of the joint structure 1 according to the present embodiment are not long enough to protrude from a side of the rivet plate 14, as illustrated in FIG. 2. Therefore, the distal ends 153c of the shafts 15 do not protrude from a side of the rivet plate 14.

Variation

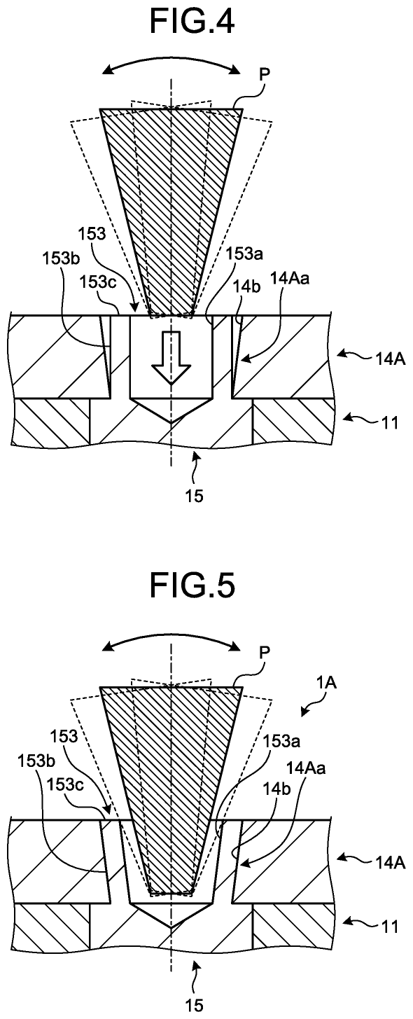

In the above joint structure 1, the through holes 14a of the rivet plate 14 have uniform inner diameters. However, through holes, such as a through hole 14Aa of a rivet plate 14A illustrated in FIG. 4, may taper and have a smaller diameter toward the arm 11 (arm 12). That is, an inner diameter of the through hole 14Aa on an arm-11 side is smaller than an inner diameter of the through hole 14Aa on a distal end 153c of a joining portion 153.

In that case, a punch P of a radial riveting machine is lowered in an axial direction of a shaft 15 at a time of riveting while the punch P is swung, as illustrated in FIG. 4. Consequently, a side of the punch P is pressed against an inner curved surface of a counterbore 153a, as illustrated in FIG. 5, and thus an inner diameter of the counterbore 153a is enlarged. Consequently, a whole outer curved surface 153b of the joining portion 153 is closely in contact with an inner curved surface 14b of the through hole 14Aa of the rivet plate 14A, as illustrated in FIG. 5. Consequently, the shaft 15 is fixed to the rivet plate 14A. As described above, a joint structure 1A includes the rivet plate 14A that includes the through hole 14Aa that tapers. Consequently, an area increases where the outer curved surface 153b of the joining portion 153 is closely in contact with the inner curved surface 14b of the through hole 14Aa. Therefore, strength increases with which the shaft 15 is fixed to the rivet plate 14A.

An embodiment has been exemplified above to describe a joint structure. However, the above description does not limit the present disclosure.

For example, in the joint structure 1, 1A according to the above embodiment, a height of the distal end 153c of the joining portion 153 is same as a height of an end, on an opening side, of the through hole 14a, 14Aa of the rivet plate 14, 14A. However, a height of the distal end 153c of the joining portion 153 may be lower than a height of an end, on an opening side, of the through hole 14a, 14Aa of the rivet plate 14, 14A. In that case, since the distal end 153c o the shaft 15 does not protrude from a side of the rivet plate 14, 14A, the joint structures 1, 1A are smaller than conventional joint structures.

In the above embodiment, the joint structures 1, 1A that each includes the arms 11, 12, the fixing plate 13, the rivet plate 14, 14A, and the shafts 15 are exemplified as an example. However, the present disclosure may be a joint structure that includes a fixed part that fixes shafts 15, and a movable part that is rotatable and is supported by the shafts 15. Therefore, the present disclosure is not limited to configurations of the above joint structures 1, 1A. For example, the present disclosure may be a joint structure in which a shaft 15 fixes one arm to a fixed part.

The joint structures 1, 1A may be applied to both a large mechanism and a small mechanism. However, the joint structures 1, 1A are effectively applied to a small mechanism that includes a shaft 15 that has a small diameter and thus is likely to deform. For example, the shaft 15 that has a small diameter is likely to swell or buckling is likely to occur at the shaft 15.

According to the present disclosure, a joining portion is fixed to a through hole of a fixed part by enlarging an inner diameter of a counterbore formed at a distal end of the joining portion of a shaft. Therefore, since a force that is in an axial direction of the shaft does not act at a time of riveting (or an axial force is slight), the shaft does not deform. For example, the shaft does not swell or buckling does not occur at the shaft. Therefore, good movement of an arm is secured. The joining portion is fixed to the through hole of the fixed part by enlarging an inner diameter of the counterbore. Therefore, the distal end of the shaft does not protrude from a side of the fixed part. Therefore, a small joint structure is manufactured according to the present disclosure.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of manufacturing a joint structure including a movable part, a fixed part that is close to the movable part, and a shaft configured to connect the movable part with the fixed part, the method comprising:
setting the shaft in a pre-fixed state in which the shaft is not fixed to the fixed part while the shaft is inserted into a through hole formed through the movable part, and a distal end of the shaft protruding from the through hole of the movable part is inserted into a through hole formed through the fixed part;
inserting a punch for riveting into an opening of a counterbore while swinging the punch, the punch including a distal end having a width narrower than a width of the counterbore formed at the distal end of the shaft, and the punch having a width gradually increasing from the distal end of the punch toward a proximal end of the punch;
pressing, by lowering the punch while swinging the punch in the counterbore, sides of the punch alternately against sides of an inner curved surface of the counterbore according to the swinging of the punch; and
fixing the shaft to the fixed part by enlarging an inner diameter of the counterbore to make the distal end of the shaft be closely in contact with the inner curved surface of the through hole of the fixed part.

2. The method according to claim 1, wherein the fixing includes lowering the punch to a lowest position where a distal-end surface of the punch does not touch a bottom surface of the counterbore while swinging the punch.
